(19) United States
(12) Patent Application Publication
(10) Pub. No.: US 2026/0038920 A1
(43) Pub. Date: Feb. 5, 2026

(54) SECONDARY BATTERY AND SECONDARY BATTERY CASE

(71) Applicant: SAMSUNG SDI CO., LTD., Yongin-si (KR)

(72) Inventor: Minhyung GUEN, Yongin-si (KR)

(21) Appl. No.: 18/978,231

(22) Filed: Dec. 12, 2024

(30) Foreign Application Priority Data
Aug. 1, 2024 (KR) 10-2024-0102375

(51) Int. Cl. H01M 50/166; H01M 10/052; H01M 50/103; H01M 50/15

(52) U.S. Cl. CPC H01M 50/166; H01M 10/052; H01M 50/103; H01M 50/15

(57) ABSTRACT

A secondary battery includes a case with at least one opening, the at least one opening having a long side portion and a short side portion, a stepped portion at the short side portion and the long side portion of the opening along an inner surface of the case, an electrode assembly accommodated in the case, and at least one cap plate joined to the at least one opening, the at least one cap plate being positioned on the stepped portion.

### CROSS-REFERENCE TO RELATED APPLICATION

This application claims priority under 35 U.S.C § 119 to Korean Patent Application No. 10-2024-0102375, filed in the Korean Intellectual Property Office on Aug. 1, 2024, the entire contents of which are hereby incorporated by reference.

### BACKGROUND

### 1. Field

Aspects of embodiments of the present disclosure relate to a secondary battery and a secondary battery case.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In general, battery structures may be classified into a top terminal type, in which a cap assembly having positive and negative terminals is positioned on one side of a battery case, and a side terminal type, in which a cap assembly having only one electrode terminal, either a positive or a negative terminal, is positioned on opposite end portions of a battery case. The side terminal type has the advantage of requiring no separate insulator for electrode separation because the positive and negative electrode caps are disposed separately at opposite end portions of the battery case and reducing process difficulty and increasing yield by lowering the component density of the cap assembly.

The above information disclosed in this Background section is for enhancement of understanding of the background of the present disclosure, and therefore, it may contain information that does not constitute related (or prior) art.

### SUMMARY

Aspects of embodiments provide a secondary battery including a case configured to have an opening with a long side portion and a short side portion in at least one end, an electrode assembly accommodated in the case, and a cap plate joined to the opening, stepped portions are formed at the short side portion and the long side portion of the opening along an inner surface of the case, so that the cap plate may be supported.

According to an embodiment, the stepped portion forms 90° with the inner surface of the case.

According to an embodiment, the stepped portion may include a plurality of sub-stepped portions spaced apart from each other at a certain interval along at least one of the short side portion or the long side portion.

According to an embodiment, the cap plate may include a plurality of protrusions formed at positions corresponding to the sub-stepped portions in a state where the cap plate may be joined to the opening.

According to an embodiment, the stepped portion may include a plurality of upper stepped portions and a plurality of lower stepped portions that are alternately arranged along at least one of the short side portion or the long side portion, and the upper stepped portions are closer to an outer end of the case than the lower stepped portions.

According to an embodiment, the lower stepped portion may be further recessed inward from the case by 0.05 mm to 0.1 mm, compared to the upper stepped portion.

According to an embodiment, the cap plate may be supported in contact with the upper stepped portion.

According to an embodiment, the stepped portion may include: a support portion extending at an angle of 90° from the inner surface of the case, and a tapered portion extending from the support portion and inclined toward an inside of the case, the cap plate may be seated on the support portion.

According to an embodiment, an inner surface of the long side portion may be inclined outward by an amount of a step of the stepped portion.

According to an embodiment, the opening may include a first opening having one end of the case open and having a first short side portion and a first long side portion, and a second opening having another end of the case open and having a second short side portion and a second long side portion, and the cap plate may include a first cap plate joined to the first opening and a second cap plate joined to the second opening.

According to an embodiment, the first opening may include a first stepped portion formed along inner surfaces of the first short side portion and the first long side portion, so that the first cap plate may be supported, and the second opening may include a second stepped portion formed along inner surfaces of the second short side portion and the second long side portion, so that the second cap plate may be supported.

According to an embodiment, the first stepped portion or the second stepped portion forms 90° with the inner surface of the case.

According to an embodiment, the first stepped portion may include a plurality of first sub-stepped portions spaced apart from each other at a certain interval along at least one of the first short side portion or the first long side portion, and the second stepped portion may include a plurality of second sub-stepped portions spaced apart from each other at a certain interval along at least one of the second short side portion or the second long side portion.

According to an embodiment, the first cap plate may include a plurality of first protrusions formed at positions corresponding to the first sub-stepped portions in a state where the first cap plate may be joined to the first opening, and the second cap plate may include a plurality of second protrusions formed at positions corresponding to the second sub-stepped portions in a state where the second cap plate may be joined to the second opening.

According to an embodiment, a recess depth of the first stepped portion may be formed to be deeper than a thickness of the first cap plate.

According to an embodiment, a recess depth of the second stepped portion may be different from a thickness of the second cap plate.

According to an embodiment, the first stepped portion may include a plurality of first upper stepped portions and a plurality of first lower stepped portions that are alternately arranged along at least one of the first short side portion or the first long side portion, the first upper stepped portions are closer to an outer end of the case than the first lower stepped portions, the second stepped portion may include a plurality of second upper stepped portions and a plurality of second lower stepped portions that are alternately arranged along at least one of the second short side portion or the second long side portion, and the second upper stepped portions are closer to the outer end of the case than the second lower stepped portions.

Aspects of embodiments further provide a secondary battery case including: a base portion configured to accommodate an internal electrode assembly, and an opening formed at one end of the base portion and including a pair of long side portions spaced apart from each other and a pair of short side portions connected to the pair of long side portions and spaced apart from each other, an inwardly recessed stepped portions are formed along inner surfaces of the short side portion and the long side portion of the opening.

According to an embodiment, the stepped portion may include a plurality of sub-stepped portions spaced apart from each other at a certain interval along at least one of the short side portion or the long side portion.

According to an embodiment, the stepped portion may include a plurality of upper stepped portions and a plurality of lower stepped portions that are alternately arranged along at least one of the short side portion or the long side portion, and the upper stepped portions are closer to an outer end of the case than the lower stepped portions.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates a perspective view showing a secondary battery according to an embodiment of the present disclosure.

FIG. 2 illustrates an exploded perspective view showing a secondary battery according to an embodiment of the present disclosure.

FIG. 3 illustrates a perspective view showing a sub-stepped portion as a stepped portion according to another embodiment of the present disclosure.

FIG. 4 illustrates a perspective view showing a cap plate applied to the stepped portion illustrated in FIG. 3.

FIG. 5 illustrates a perspective view showing an upper stepped portion and a lower stepped portion as a stepped portion according to another embodiment of the present disclosure.

FIGS. 6A to 6C schematically illustrate variations of a joined state of a case and a cap plate in a secondary battery according to embodiments of the present disclosure.

FIG. 7 illustrates a perspective view showing a secondary battery case according to an embodiment of the present disclosure.

FIG. 8 illustrates an exploded perspective view showing a case where a secondary battery according to an embodiment of the present disclosure is of a side terminal type.

FIG. 9 illustrates a perspective view showing a first sub-stepped portion and a second sub-stepped portion as a stepped portion according to an embodiment, which is different from that of FIG. 8.

FIG. 10 illustrates a perspective view showing a first cap plate and a second cap plate applied to the stepped portion illustrated in FIG. 9.

FIG. 11 illustrates a perspective view showing a first upper stepped portion, a first lower stepped portion, a second upper stepped portion, and a second lower stepped portion as a stepped portion according to another embodiment of the present disclosure.

FIG. 12 schematically illustrates a joined state of a secondary battery case, a first cap plate, and a second cap plate in a case where a secondary battery according to an embodiment of the present disclosure is a side terminal type.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

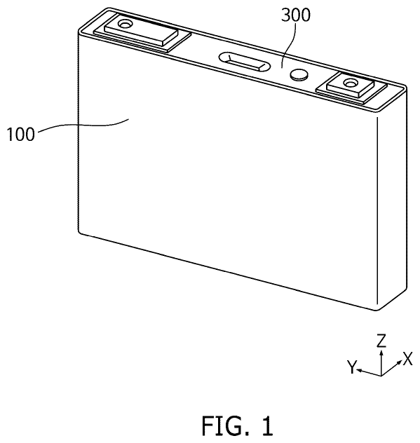

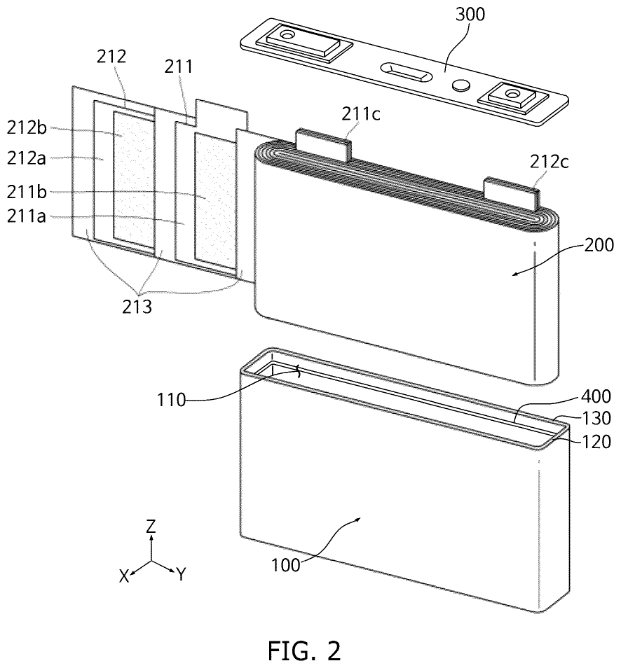

FIG. 1 illustrates a perspective view showing a secondary battery according to an embodiment of the present disclosure, and FIG. 2 illustrates an exploded perspective view showing the secondary battery according to an embodiment of the present disclosure.

Referring to FIGS. 1 and 2, the secondary battery according to an embodiment of the present disclosure may include a case 100 having an opening formed therein, an electrode assembly 200 accommodated in the case 100, and a cap plate 300. In the present embodiment, the present disclosure is described focusing on a prismatic secondary battery of a top terminal type.

In an embodiment, the case 100 may be formed of a metal material having a rectangular solid shape. The case 100 may have an opening 110 with a long side portion 130 and a short side portion 120 in at least one end. The case 100 itself may serve as a secondary battery terminal. The long side portion 130 may be defined as being relatively long compared to the short side portion 120, and the short side portion 120 may be defined as being relatively short compared to the long side portion 130.

The long side portion 130 may extend in the Y direction of FIG. 1, and the short side portion 120 may be connected to the long side portion 130 and extend in the X direction of FIG. 1. The long side portions 130 may be formed as a pair spaced apart from each other, and the short side portions 120 may be formed as a pair connected to the pair of long side portions 130 and spaced apart from each other.

A material of the case 100 may be aluminum or an aluminum alloy, which is a lightweight conductive metal. The opening 110 may be formed in at least one end of the case 100, so that the electrode assembly 200 may be accommodated inside the case 100 through the opening 110. In an embodiment, the opening 110 may be formed at the upper end of the case 100.

The electrode assembly 200 may be accommodated in the case 100. The electrode assembly 200 may be formed by winding or stacking a laminate of a first electrode plate 211, a separator 213, and a second electrode plate 212, which are formed in a thin plate or film shape. The first electrode plate 211 may act as a negative electrode, and the second electrode plate 212 may act as a positive electrode, e.g., the opposite is also possible.

The first electrode plate 211 may be formed by applying a first electrode active material 211b, e.g., graphite or carbon, to a first electrode current collector 211a formed of a metal foil, e.g., copper, a copper alloy, nickel, or a nickel alloy, and may include a first electrode uncoated portion that is a region where the first electrode active material 211b is not applied. In addition, the first electrode plate 211 may include a first multi-tab 211c that extends upward from the first electrode uncoated portion by a certain length, and the first multi-tab 211c serves as a passage for current flow between the first electrode plate 211 and the outside of the first electrode plate 211. In addition, the multi-tab 211c may include a plurality of tabs, but the present disclosure may be varied, e.g., the multi-tab may include one tab.

The second electrode plate 212 may be formed by applying a second electrode active material 212b, e.g., transition metal oxide, to a second electrode current collector 212a formed of a metal foil, e.g., aluminum or an aluminum alloy, and may include a second electrode uncoated portion that is a region where the second electrode active material 212b is not applied. In addition, the second electrode plate 212 may include a second multi-tab 212c that extends upward from the second electrode uncoated portion by a certain length, and the second multi-tab 212c serves as a passage for current flow between the second electrode plate 212 and the outside of the second electrode plate 212. The first and second multi-tabs 211c and 212c are maintained in a state of being approximately parallel to each other.

The first electrode plate 211 and the second electrode plate 212 as described above may be arranged with different polarities. The winding axis of the electrode assembly 200 may be formed approximately parallel to or approximately horizontal to the terminal axis of the first terminal and the second terminal of the cap plate 300.

The separator 213 may be positioned between the first electrode plate 211 and the second electrode plate 212 to prevent a short circuit and enable movement of lithium ions, and may be formed of, e.g., polyethylene, polypropylene, or a composite film of polyethylene and polypropylene.

The cap plate 300 may be joined to the opening 110 of the case 100. The opening 110 is not illustrated in FIG. 1 because the case 100 and the cap plate 300 are joined to each other, but the peripheral portion of the cap plate 300 may be a substantially opened portion.

Referring to FIG. 2, a stepped portion 400, on which the cap plate 300 is supported, may be formed (e.g., continuously) along the inner surface of the case 100 at the short side portion 120 and the long side portion 130 of the opening 110. In an embodiment, the stepped portion 400 may form 90° with the inner surface of the case 100. For example, referring to FIG. 2, the stepped portion 400 may protrude from a sidewall of the case 100 toward an interior of the case 100 at an upper portion of the case 100, e.g., at a same height as a bottom of the cap plate 300 relative to a bottom of the case 100.

For example, the stepped portion 400 may be formed by being recessed along the inner surface of the case 100 in a step shape. The thickness of the case 100 in which the stepped portion 400 is formed may be thinner than the thickness of the case 100 in which the stepped portion 400 is not formed (e.g., a thickness of a sidewall of the case 100 in which the stepped portion 400 is formed may be thinner than a thickness of a sidewall of the case 100 in which the stepped portion 400 is not formed).

In an embodiment, the stepped portion 400 may be configured to support the lower end portion of the cap plate 300. The stepped portion 400 may be formed in the entire opening 110 (e.g., along the entire inner perimeter of the opening 110) along the long side portion 130 and the short side portion 120. The stepped portion 400 formed along the long side portion 130 may be formed by being recessed toward the outside of the case 100 in the X direction in the drawing. The stepped portion 400 formed along the short side portion 120 may be formed by being recessed toward the outside of the case 100 in the Y direction in the drawing. For example, referring to FIG. 2, an inner sidewall of the case 100 overlapping the cap plate 300 may be offset relative an inner sidewall of the case 100 overlapping the electrode assembly 200 in the X and Y directions by the stepped portion 400 (e.g., offset in a direction oriented from a center of the case 100 toward an exterior of the case 100).

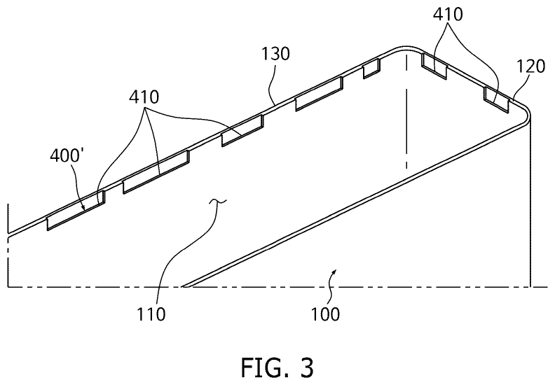

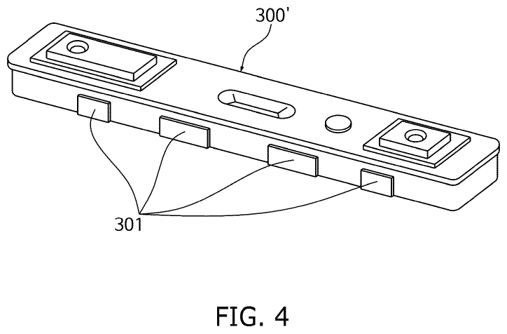

FIG. 3 illustrates a perspective view showing a sub-stepped portion as a stepped portion according to another embodiment of the present disclosure, and FIG. 4 illustrates a perspective view showing a cap plate applied to the stepped portion illustrated in FIG. 3.

Referring to FIGS. 3 and 4, a stepped portion 400′ may include a plurality of sub-stepped portions 410 spaced apart from each other at a certain interval along at least one of a short side portion 120 or a long side portion 130. The sub-stepped portion 410 formed along the long side portion 130 may be formed by being recessed toward the outside of a case 100 in the X direction in the drawing. The sub-stepped portion 410 formed along the short side portion 120 may be formed by being recessed toward the outside of the case 100 in the Y direction in the drawing.

The sub-stepped portions 410 may be formed with the same width or may be formed with different widths (e.g., lengths measured along a perimeter of the opening 110 and/or widths measured from the inner sidewall of the case 100 toward a center of the case 100). In addition, the spacing between the sub-stepped portions 410 may be formed identically or differently.

A cap plate 300′ may include a plurality of protrusions 301 formed at positions corresponding to (e.g., overlapping or aligned with) the sub-stepped portions 410 in a state where the cap plate 300 is joined to the opening 110. The protrusions 301 may be formed with the same width or may be formed with different widths. In addition, the spacing between the protrusions 301 may be formed identically or differently.

In an embodiment, in a case where the cap plate 300′ illustrated in FIG. 4 is joined to the case 100 illustrated in FIG. 3, the lower end portion of the cap plate 300′ may be supported on the sub-stepped portions 410. The protrusions 301 may be joined to the sub-stepped portions 410 corresponding thereto.

The thickness of the case 100 (e.g., thickness of sidewalls of the case 100) where the sub-stepped portions 410 are not formed may be thicker than the thickness of the case 100 where the sub-stepped portions 410 are formed. Therefore, according to the present embodiment, the cap plate 300 may be stably supported on the case 100 (e.g., on the stepped portion 400′ of the case 100) while maintaining the durability of the entire secondary battery. In addition, it is possible to prevent the secondary battery from breaking due to increased internal pressure.

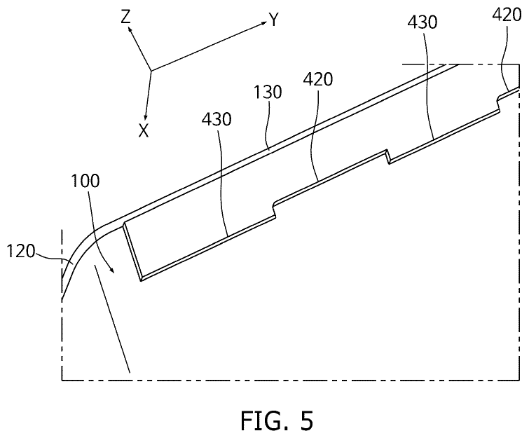

FIG. 5 illustrates a perspective view showing an upper stepped portion and a lower stepped portion as a stepped portion according to yet another embodiment of the present disclosure.

Referring to FIG. 5, the stepped portion may include a plurality of upper stepped portions 420 and a plurality of lower stepped portions 430 that are alternately disposed along at least one of a short side portion 120 or a long side portion 130. At this time, the upper stepped portions 420 may be closer to an outer end of the case 100 than the lower stepped portions 430 are. For example, the depth of the upper stepped portions 420 may be shallower than the depth of the lower stepped portions 430 (e.g., a distance along the Z direction between topmost surfaces of the upper stepped portions 420 and a topmost surface of the case 100 may be smaller than a distance along the Z direction between topmost surfaces of the lower stepped portions 430 and the topmost surface of the case 100).

The upper stepped portion 420 formed along the long side portion 130 may be formed by being recessed toward the outside of the case 100 in the X direction in the drawing. The upper stepped portion 420 formed along the short side portion 120 may be formed by being recessed toward the outside of the case 100 in the Y direction in the drawing.

The lower stepped portion 430 formed along the long side portion 130 may be formed by being recessed toward the outside of the case 100 in the X direction in the drawing. The lower stepped portion 430 formed along the short side portion 120 may be formed by being recessed toward the outside of the case 100 in the Y direction in the drawing.

The upper stepped portions 420 may be formed with the same width in the Y direction or may be formed with different widths in the Y direction. The lower stepped portions 430 may be formed with the same width in the Y direction or may be formed with different widths in the Y direction.

In an embodiment, the lower stepped portion 430 may be further recessed inward from the case 100 by 0.05 mm to 0.1 mm, compared to the upper stepped portion 420. That is, the lower stepped portion 430 may be further recessed inward from the case 100 in the Z direction by 0.05 mm to 0.1 mm, compared to the upper stepped portion 420 (e.g., a height difference in the Z direction between the lower stepped portion 430 and the upper stepped portion 420 may be 0.05 mm to 0.1 mm).

In the embodiment disclosed in FIG. 5, the cap plate 300 may be supported in contact with the upper stepped portion 420. The cap plate 300 may be in contact (e.g., direct contact) with the upper stepped portions 420 and may be kept horizontal. In a state where the cap plate 300 is supported in contact with the upper stepped portions 420, the lower stepped portions 430 may not be in contact with the cap plate 300.

The lower stepped portion 430 may secondarily support the cap plate 300 in a case where the upper stepped portion 420 is damaged due to external damage or the like. That is, in a case where a strong load is applied from the outside in the Z direction or in a case where vibration is transmitted and the upper stepped portion 420 supporting the lower end of the cap plate 300 falls toward the lower stepped portion 430, the lower stepped portion 430 may support the lower end of the cap plate 300 to maintain the rigidity of the secondary battery.

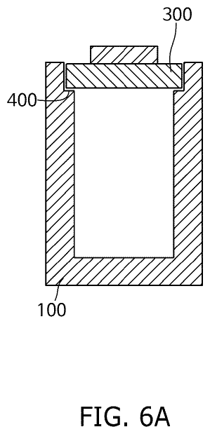

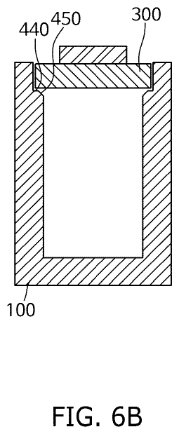

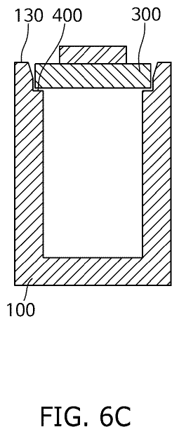

FIGS. 6A-6C schematically illustrate a joined state of a case and a cap plate in a secondary battery according to an embodiment of the present disclosure.

Referring to FIGS. 6A-6C, the shape of the stepped portion 400 and the shape of the cap plate 300 may be variously modified. In various embodiments, a top terminal type secondary battery is illustrated, but various embodiments may be equally applied to a side terminal type secondary battery. In addition, the recessed depth of the stepped portion 400 may be equal to or different from the thickness of the cap plate 300 (e.g., in the Z direction in FIGS. 1-2).

For example, referring to FIG. 6A, the case 100 may have a rectangular solid shape, and the stepped portion 400 may form 90° with the inner surface of the case 100. At this time, the lower end portion of the cap plate 300 supported on the stepped portion 400 may be formed at a right angle.

In another example, referring to FIG. 6B, the stepped portion may include a support portion 440 and a tapered portion 450. The support portion 440 may be formed to extend at an angle of 90° from the inner surface of the case 100. The tapered portion 450 may be formed to extend from the support portion 440 and may be inclined toward the inside of the case 100. The degree of inclination of the tapered portion 450 may be variously changed. The cap plate 300 may be seated on the support portion 440. The case 100 may have a rectangular solid shape, and the lower end portion of the cap plate 300 supported on the support portion 440 may be formed at a right angle.

In yet another example, referring to FIG. 6C, the case 100 may have a rectangular solid shape, and the stepped portion 400 may form 90° with the inner surface of the case 100. At this time, the lower end portion of the cap plate 300 supported on the stepped portion 400 may be formed at a right angle. In addition, the inner surface of the long side portion 130 may be inclined outward by the amount of the step of the stepped portion 400. Thus, the upper end portion of the cap plate 300 may not come into contact with the inner surface of the case 100 and a separation space may be formed therein. Accordingly, the cap plate 300 may be stably supported while preventing the cap plate 300 from moving and causing damage to the inner surface of the case 100 in a case where external vibration or the like is transmitted in the width direction of the case 100.

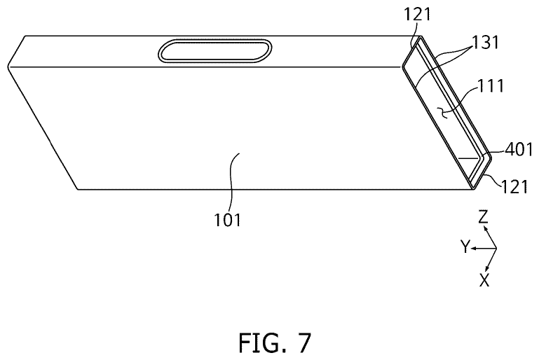

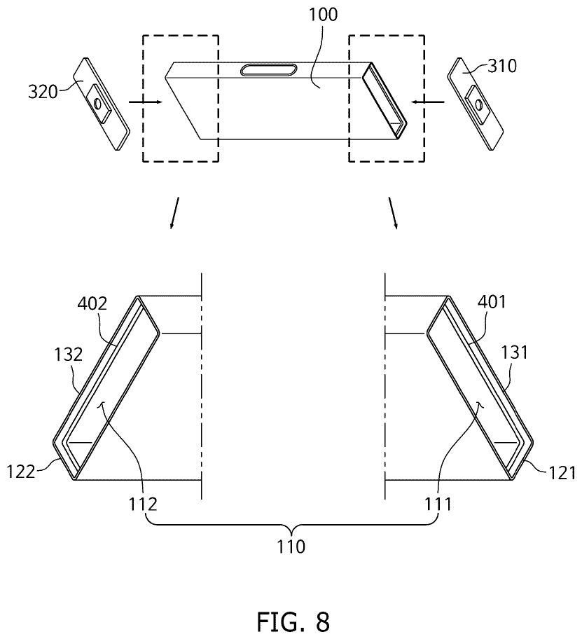

FIG. 7 illustrates a perspective view showing a secondary battery case according to still another embodiment of the present disclosure, and FIG. 8 illustrates an exploded perspective view of the secondary battery of FIG. 7. It is noted that FIGS. 7-8 illustrate an embodiment of a secondary battery with a side terminal type.

Referring to FIGS. 7 and 8, the secondary battery case according to the present disclosure may include a base portion 101 that accommodates an internal electrode assembly, and openings 111 and 112 formed at opposite ends of the base portion 101, respectively. The openings 111 and 112 may include a pair of long side portions 131 and 132, respectively, spaced apart from each other and a pair of short side portions 121 and 122, respectively, connected to the pair of long side portions 131 and 132 and spaced apart from each other. In an embodiment, inwardly recessed step portions 401 and 402 may be formed along the inner surfaces of the short side portions 121 and 122 and the long side portions 131 and 132 of the openings 111 and 112, respectively.

The secondary battery case may be a side terminal type having the base portion 101 that accommodates an electrode assembly and a positive electrode terminal and a negative electrode terminal that are disposed at opposite ends of the base portion 101 and individually connected to positive and negative electrodes of the electrode assembly.

For example, the case 100 may be provided as a side terminal type open prismatic cylinder having the pair of openings 111 and 112 with opposite ends open. For example, the case 100 is provided as a three-dimensional structure formed through a single forging process or an assembly process of multiple plates and has an accommodation space inside, and an electrode assembly and an electrolyte may be accommodated in the accommodation space.

In another example, the secondary battery case according to the present disclosure may be a top terminal type in which the upper end of the base portion 101 is open and has one opening. For example, the base portion 101 may be formed of aluminum and an aluminum alloy.

In the case of the side terminal type secondary battery, the opening 110 may include the first opening 111 and the second opening 112. The first opening 111 may have one end of the case 100 open and may have the first short side portion 121 and the first long side portion 131. The second opening 112 may have the other end of the case 100 open and may have the second short side portion 122 and the second long side portion 132.

The cap plate 300 may include a first cap plate 310 and a second cap plate 320. The first cap plate 310 may be joined to the first opening 111. The second cap plate 320 may be joined to the second opening 112.

In an embodiment, the first stepped portion 401 on which the first cap plate 310 is supported may be formed in the first opening 111 along the inner surfaces of the first short side portion 121 and the first long side portion 131. The first stepped portion 401 may form 90° with the inner surface of the case 100. The first stepped portion 401 may be configured to support the lower end portion of the first cap plate 310.

The first stepped portion 401 may be formed in the entire first opening 111 along the first long side portion 131 and the first short side portion 121. The first stepped portion 401 may be configured to support one entire end portion of the first cap plate 310. The first stepped portion 401 formed along the first long side portion 131 may be formed by being recessed toward the outside of the base portion 101. The first stepped portion 401 formed along the first short side portion 121 may be formed by being recessed toward the outside of the base portion 101.

In an embodiment, the second stepped portion 402 on which the second cap plate 320 is supported may be formed in the second opening 112 along the inner surfaces of the second short side portion 122 and the second long side portion 132. The second stepped portion 402 may form 90° with the inner surface of the case 100. The second stepped portion 402 may be configured to support the lower end portion of the second cap plate 320.

The second stepped portion 402 may be formed in the entire second opening 112 along the second long side portion 132 and the second short side portion 122. The second stepped portion 402 may be configured to support one entire end portion of the second cap plate 320. The second stepped portion 402 formed along the second long side portion 132 may be formed by being recessed toward the outside of the base portion 101. The second stepped portion 402 formed along the second short side portion 122 may be formed by being recessed toward the outside of the base portion 101.

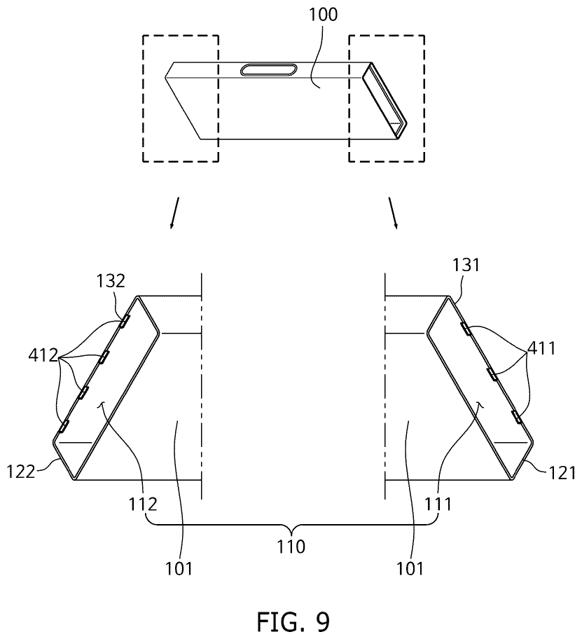

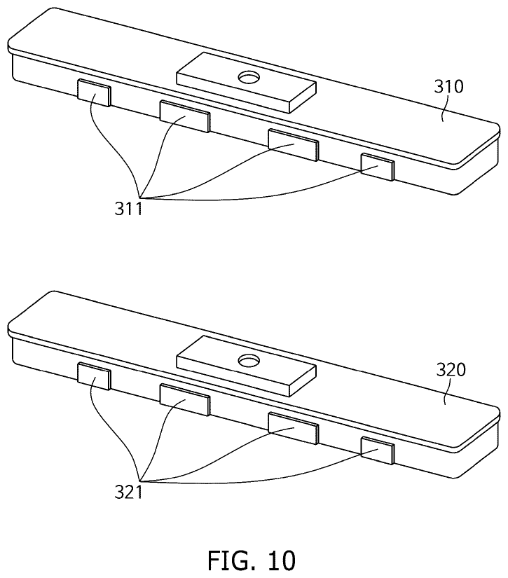

FIG. 9 illustrates a perspective view showing a first sub-stepped portion and a second sub-stepped portion as a stepped portion according to an embodiment, which is different from that of FIG. 8, and FIG. 10 illustrates a perspective view showing a first cap plate and a second cap plate applied to the stepped portion illustrated in FIG. 9.

Referring to FIGS. 9 and 10, the first stepped portion may include a plurality of first sub-stepped portions 411, and the second stepped portion may include a plurality of second sub-stepped portions 412. The first sub-stepped portions 411 may be formed spaced apart at a certain interval along at least one of a first short side portion 121 or a first long side portion 131. The second sub-stepped portions 412 may be formed spaced apart at a certain interval along at least one of a second short side portion 122 or a second long side portion 132.

The first sub-stepped portion 411 formed along the first long side portion 131 may be formed by being recessed toward the outside of the base portion 101. The first sub-stepped portion 411 formed along the first short side portion 121 may be formed by being recessed toward the outside of the base portion 101.

The first sub-stepped portions 411 may be formed with the same width or may be formed with different widths. In addition, the spacing between the first sub-stepped portions 411 may be formed identically or differently.

The second sub-stepped portion 412 formed along the second long side portion 132 may be formed by being recessed toward the outside of the base portion 101. The second sub-stepped portion 412 formed along the second short side portion 122 may be formed by being recessed toward the outside of the base portion 101.

The second sub-stepped portions 412 may be formed with the same width or may be formed with different widths. In addition, the spacing between the second sub-stepped portions 412 may be formed identically or differently.

A first cap plate 310 may include a plurality of first protrusions 311 formed at positions corresponding to the first sub-stepped portions 411 in a state where the first cap plate 310 is joined to a first opening 111. The first protrusions 311 may be formed with the same width or may be formed with different widths. In addition, the spacing between the first protrusions 311 may be formed identically or differently.

In an embodiment, in a case where the first cap plate 310 illustrated in FIG. 10 is joined to the case 100 illustrated in FIG. 9, one end portion of the first cap plate 300 may be supported on the first sub-stepped portions 411. The first protrusions 311 may be joined to the first sub-stepped portions 411 corresponding thereto.

A second cap plate 320 may include a plurality of second protrusions 321 formed at positions corresponding to the second sub-stepped portions 412 in a state where the second cap plate 320 is joined to a second opening 112. The second protrusions 321 may be formed with the same width or may be formed with different widths. In addition, the spacing between the second protrusions 321 may be formed identically or differently.

In an embodiment, in a case where the second cap plate 320 illustrated in FIG. 10 is joined to the case 100 illustrated in FIG. 9, one end portion of the second cap plate 320 may be supported on the second sub-stepped portions 412. The second protrusions 321 may be joined to the second sub-stepped portions 412 corresponding thereto.

The thickness of the case 100 in which the first sub-stepped portion 411 and the second sub-stepped portion 412 are not formed may be thicker than the thickness of the case 100 in which the first sub-stepped portion 411 and the second sub-stepped portion 412 are formed. Therefore, according to the present embodiment, in the side terminal type secondary battery, the first cap plate 310 and the second cap plate 320 may be stably supported by the case 100 while maintaining the durability of the entire secondary battery. In addition, it is possible to prevent the secondary battery from breaking due to increased internal pressure.

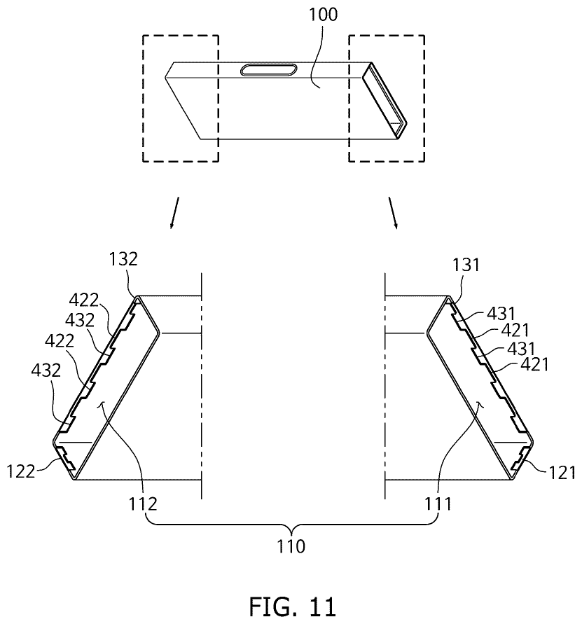

FIG. 11 illustrates a perspective view showing a first upper stepped portion, a first lower stepped portion, a second upper stepped portion, and a second lower stepped portion as a stepped portion according to another embodiment of the present disclosure.

Referring to FIG. 11, a first stepped portion may include a plurality of first upper stepped portions 421 and a plurality of first lower stepped portions 431. The first upper stepped portions 421 may be alternately disposed along at least one of a first short side portion 121 or a first long side portion 131. The first upper stepped portions 421 may be formed closer to an outer end of a case 100 than the first lower stepped portions 431.

In an embodiment, the first lower stepped portion 431 may be further recessed inward from the case 100 by 0.05 mm to 0.1 mm, compared to the first upper stepped portion 421. That is, the first lower stepped portion 431 may be further recessed inward from the case 100 by 0.05 mm to 0.1 mm, compared to the first upper stepped portion 421.

In the embodiment disclosed in FIG. 11, the first cap plate 310 of FIG. 8 may be supported in contact with the first upper stepped portion 421. The first cap plate 310 may be in contact with the first upper stepped portions 421 and may be kept horizontal. In a state where the first cap plate 310 is supported in contact with the first upper stepped portions 421, the first lower stepped portion 431 may not be in contact with the first cap plate 310.

The first lower stepped portion 431 may secondarily support the first cap plate 310 in a case where the first upper stepped portion 421 is damaged due to external damage or the like. That is, in a case where a strong load is applied from the outside or in a case where vibration is transmitted and the first upper stepped portion 421 supporting one end of the first cap plate 310 falls toward the first lower stepped portion 431, the first lower stepped portion 431 may support one end of the first cap plate 310 to maintain the rigidity of the secondary battery.

The second stepped portion may include a plurality of second upper stepped portions 422 and a plurality of second lower stepped portions 432. The second upper stepped portions 422 may be alternately disposed along at least one of a second short side portion 122 or a second long side portion 132. The second upper stepped portions 422 may be formed closer to the outer end of the case 100 than the second lower stepped portions 432.

In an embodiment, the second lower stepped portion 432 may be further recessed inward from the case 100 by 0.05 mm to 0.1 mm, compared to the second upper stepped portion 422. That is, the second lower stepped portion 432 may be further recessed inward from the case 100 by 0.05 mm to 0.1 mm, compared to the second upper stepped portion 422.

In the embodiment disclosed in FIG. 11, the second cap plate 320 of FIG. 8 may be supported in contact with the second upper stepped portion 422. The second cap plate 320 may be in contact with the second upper stepped portions 422 and may be kept horizontal. In a state where the second cap plate 320 is supported in contact with the second upper stepped portions 422, the second lower stepped portion 432 may not be in contact with the second cap plate 320.

The second lower stepped portion 432 may secondarily support the second cap plate 320 in a case where the second upper stepped portion 422 is damaged due to external damage or the like. That is, in a case where a strong load is applied from the outside or in a case where vibration is transmitted and the second upper stepped portion 422 supporting one end of the second cap plate 320 falls toward the second lower stepped portion 432, the second lower stepped portion 432 may support one end of the second cap plate 320 to maintain the rigidity of the secondary battery.

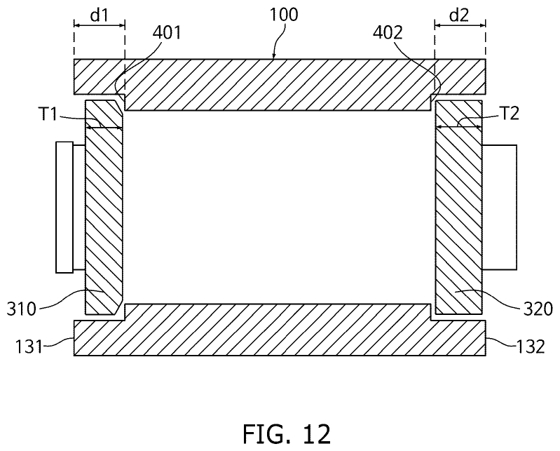

FIG. 12 schematically illustrates a joined state of a secondary battery case, a first cap plate, and a second cap plate in a case where a secondary battery according to an embodiment of the present disclosure is a side terminal type.

Referring to FIG. 12, a recessed depth d1 of s first stepped portion 401 may be formed to be deeper than a thickness T1 of a first cap plate 310. In the present embodiment, although the first stepped portion 401 formed on a first long side portion 131 is illustrated, the first stepped portion 401 formed on a first short side portion may also be applied in the same manner.

According to an embodiment, a recessed depth d2 of a second stepped portion 402 may be different from a thickness T2 of a second cap plate 320. In the present embodiment, although the second stepped portion 402 formed on a second long side portion 132 is illustrated, the second stepped portion 402 formed on a second short side portion may also be applied in the same manner.

In the case of the side terminal type secondary battery, the positive and negative electrode cap plates 310 and 320 have to be joined to each position, but according to the present embodiment, the distinction may be made easily due to the height difference between the first stepped portion 401 and the second stepped portion 402 of the positive and negative electrodes. Therefore, a defect rate in a secondary battery assembly process may be reduced.

By way of summation and review, the top terminal type battery structure and the side terminal type battery structure may be configured to support the cap assembly by providing a certain step only in a short side portion among the long and short side portions of a battery case opening into which the cap assembly is assembled. Therefore, in a case where external damage is applied to the secondary battery, the support force of the cap assembly may be weak, which may cause durability problems. Accordingly, it is desirable to provide a structure capable of stably combining a cap assembly to a battery case to improve the durability of a secondary battery.

Therefore, the present disclosure provides a secondary battery capable of stably supporting a cap plate through a step portion extending from a long side portion and a short side portion of a case. The present disclosure also provides a secondary battery case as described above.

That is, in the secondary battery and the secondary battery case according to the present disclosure, the durability of the secondary battery may be improved by stably supporting the cap plate through the stepped portion formed by extending from the long side portion and the short side portion of the case. In addition, because it is easy to distinguish the positive electrode and the negative electrode in the insert process of the case and the cap plate, the defect rate in the process may be reduced. Furthermore, due to the application of the two-stage stepped portion, the cap plate may be supported on the second-stage stepped portion even in a case where the first-stage stepped portion collapses due to the load or vibration applied to the secondary battery. Accordingly, the rigidity of the secondary battery may be maintained even under strong external damage.

However, aspects and features of the present disclosure are not limited to those described above, and other aspects and features not mentioned will be clearly understood by a person skilled in the art from the detailed description, described above.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
a case with at least one opening, the at least one opening having a long side portion and a short side portion;
a stepped portion at the short side portion and the long side portion of the at least one opening along an inner surface of the case;
an electrode assembly accommodated in the case; and
at least one cap plate joined to the at least one opening, the at least one cap plate being positioned on the stepped portion.

2. The secondary battery as claimed in claim 1, wherein the stepped portion is at 90° with the inner surface of the case.

3. The secondary battery as claimed in claim 1, wherein the stepped portion includes a plurality of sub-stepped portions spaced apart from each other at a certain interval along at least one of the short side portion and the long side portion.

4. The secondary battery as claimed in claim 3, wherein the at least one cap plate includes a plurality of protrusions at positions corresponding to the plurality of sub-stepped portions in a state where the at least one cap plate is joined to the at least one opening.

5. The secondary battery as claimed in claim 1, wherein the stepped portion includes a plurality of upper stepped portions and a plurality of lower stepped portions that are alternately arranged along at least one of the short side portion or the long side portion, the plurality of upper stepped portions being closer to an outer end of the case than the plurality of lower stepped portions are.

6. The secondary battery as claimed in claim 5, wherein a height difference between the plurality of lower stepped portions and the plurality of upper stepped portions is 0.05 mm to 0.1 mm.

7. The secondary battery as claimed in claim 5, wherein the at least one cap plate is in contact with the plurality of upper stepped portions.

8. The secondary battery as claimed in claim 1, wherein:
the stepped portion includes:
a support portion extending at an angle of 90° from the inner surface of the case, and
a tapered portion extending from the support portion and inclined toward an inside of the case, and
the at least one cap plate is seated on the support portion.

9. The secondary battery as claimed in claim 1, wherein an inner surface of the long side portion is inclined outward by an amount of a step of the stepped portion.

10. The secondary battery as claimed in claim 1, wherein:
the at least one opening includes a first opening at one end of the case open and a second opening at another end of the case, the first opening including a first short side portion and a first long side portion, and the second opening including a second short side portion and a second long side portion, and
the at least one cap plate includes a first cap plate joined to the first opening and a second cap plate joined to the second opening.

11. The secondary battery as claimed in claim 10, wherein:
the first opening includes a first stepped portion along inner surfaces of the first short side portion and the first long side portion, the first cap plate being on the first stepped portion, and
the second opening includes a second stepped portion along inner surfaces of the second short side portion and the second long side portion, the second cap plate being on the second stepped portion.

12. The secondary battery as claimed in claim 11, wherein at least one of the first stepped portion and the second stepped portion extends at 90° with the inner surface of the case.

13. The secondary battery as claimed in claim 11, wherein:
the first stepped portion includes a plurality of first sub-stepped portions spaced apart from each other at a certain interval along at least one of the first short side portion and the first long side portion, and
the second stepped portion includes a plurality of second sub-stepped portions spaced apart from each other at a certain interval along at least one of the second short side portion and the second long side portion.

14. The secondary battery as claimed in claim 13, wherein:
the first cap plate includes a plurality of first protrusions at positions corresponding to the first sub-stepped portions in a state where the first cap plate is joined to the first opening, and
the second cap plate includes a plurality of second protrusions at positions corresponding to the second sub-stepped portions in a state where the second cap plate is joined to the second opening.

15. The secondary battery as claimed in claim 11, wherein a recess depth of the first stepped portion is deeper than a thickness of the first cap plate.

16. The secondary battery as claimed in claim 11, wherein a recess depth of the second stepped portion is different from a thickness of the second cap plate.

17. The secondary battery as claimed in claim 11, wherein:
the first stepped portion includes a plurality of first upper stepped portions and a plurality of first lower stepped portions that are alternately arranged along at least one of the first short side portion or the first long side portion, the first upper stepped portions being closer to an outer end of the case than the first lower stepped portions are, and
the second stepped portion includes a plurality of second upper stepped portions and a plurality of second lower stepped portions that are alternately arranged along at least one of the second short side portion or the second long side portion, the second upper stepped portions being closer to the outer end of the case than the second lower stepped portions are.

18. A secondary battery case, comprising:
a base portion accommodating an internal electrode assembly;
a pair of openings at opposite ends of the base portion, respectively, the pair of openings including a pair of long side portions spaced apart from each other and a pair of short side portions connected to the pair of long side portions and spaced apart from each other; and
a stepped portion along inner surfaces of the pair of short side portions and the pair of long side portions of the pair openings.

19. The secondary battery case as claimed in claim 18, wherein the stepped portion includes a plurality of sub-stepped portions spaced apart from each other at a certain interval along at least one of the pairs of short side portions and the pair of long side portions.

20. The secondary battery case as claimed in claim 18, wherein the stepped portion includes a plurality of upper stepped portions and a plurality of lower stepped portions that are alternately arranged along at least one of the pairs of short side portions and long side portions, the plurality of upper stepped portions being closer to an outer end of the case than the plurality of lower stepped portions.
